(19) United States
(12) Patent Application Publication
(10) Pub. No.: US 2007/0284200 A1
(43) Pub. Date: Dec. 13, 2007

(54) Brake disc assembly and method of construction

(75) Inventor: Keith Hampton, Ann Arbor, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal-Mogul World Wide, Inc.

(21) Appl. No.: 11/450,728

(22) Filed: Jun. 9, 2006

(51) Int. Cl. F16D 65/12

(52) U.S. Cl. 188/218 XL

(57) ABSTRACT

A brake disc assembly comprises a rotor and a hat assembly. The hat assembly is comprised of two hat portions, each having a plurality of curved projections. The curved projections interact with radial recesses formed in the rotor to ensure a secure connection between the hat assembly and the rotor over a wide range of operating conditions.

### RELATED APPLICATIONS

None.

### STATEMENT REGARDING FEDERALLY SPONSORED RESEARCH

None.

### TECHNICAL FIELD

The present invention relates to a brake disc assembly and a method for assembling the same that provides improved performance over a wide range of operating conditions.

### BACKGROUND OF THE INVENTION

Brake disc assemblies are well-known in the art and are commonly used, for example, as a component of braking systems of motor vehicles. A brake disc or rotor is arranged to rotate with a member, such as a wheel or axle of a vehicle. Such a rotor provides two oppositely-facing annular friction surfaces that, in the operation of the brake, are engaged by blocks of friction material to decelerate the rotor and hence the member. Two of the friction material blocks are moved (usually by hydraulic means) towards one another into contact with the two friction surfaces so that frictional forces occur, which slows the rotation of the rotor, and hence the member. These frictional forces generate a considerable amount of heat that tends to be absorbed by the rotor and causes its temperature to rise. As the temperature of the rotor increases, the braking performance may be adversely affected, e.g., the coefficient of friction between the rotor and the brake pads decreases as the temperature of the rotor increases.

It is conventional to form the rotor so that it comprises a first generally disc-shaped portion that provides one of the annular surfaces, and a second generally disc-shaped portion that provides the other of the annular surfaces. The first and second portions are of constant thickness and are arranged in spaced parallel relationship. These portions are joined by vanes between which are cooling ducts or passageways extending radially outwardly of the rotor. The cooling ducts are arranged so that, as the rotor is rotated, air passes through the ducts and acts to cool the portions of the rotor on the side opposite of the annular surfaces. Air inlets to the ducts are provided at an inner edge of the first and second portions and the rotor functions as a centrifugal fan driving air outwardly to outlets at the outer edges of the portions. Typically, the passageways extend in straight lines radially of the rotor and each passageway is of constant thickness along its length. Even with this conventional construction, poor performance due to high temperatures remains a problem.

Further, prior art brake disc assemblies are quite heavy. In currently used systems, the rotor is constructed of cast-iron, which has the requisite strength but is relatively heavy. The weight of the rotor is detrimental to both fuel efficiency and steering. The brakes represent an unsprung mass on the wheel that must be turned and steered, and also supported to withstand high loads including the brake torque and loads due to a wheel going up and down as it travels over uneven road surfaces. Further, the large mass of the rotor reduces the natural frequency of the suspension, which leads to lack of traction between the road and the tire. This lack of traction affects the handling of the vehicle and is also felt as poor ride. For these reasons, a reduction in the weight of the brake disc assembly is a desirable goal.

In order to address the heat-related and weight issues described above, it is desirable to form disc brake rotors out of a material that (i) has better thermal characteristics, including but not limited to better friction and higher strength at high temperatures, than the cast-iron that is traditionally used, and (ii) is lightweight. Ceramic materials (for example, carbon fiber reinforced silicon carbide) are good candidates because they generally have better thermal characteristics and a lower weight than the traditionally used cast-iron material. These ceramic materials, however, suffer from a number of different limitations, such as a lower tensile strength and toughness and a high cost of manufacture.

### SUMMARY OF THE INVENTION

In view of the above, there exists a need for a brake disc assembly that is both lightweight and resistant to the heat-related problems described above. Further, there is a need for a brake disc assembly that provides better performance over a range of operating conditions. Finally, there is a need for a brake disc assembly design that allows for the use of ceramic and other materials with desirable qualities to form parts of the brake disc assembly without reducing its performance.

To meet these and other needs that will be apparent to those skilled in the art based upon this description and the appended drawings, the present invention is directed to a brake disc assembly comprising a rotor and a hat assembly. The rotor includes an opening that has a plurality of radial recesses each with a first and second side portion. The hat assembly is operably connected to the rotor and comprises a first hat portion and a second hat portion. Each of the first and second hat portions is bowl-shaped and has a body, a hat opening and a plurality of curved projections. The curved projections extend outwardly from the body portion. The first hat portion is arranged such that each of its curved projections contact one of the first side portions and the second hat portion is arranged such that each of its curved projections contact one of the second side portions. The first hat portion is nested within the second hat portion.

In another embodiment of the present invention, a method of assembling a brake disc assembly is disclosed. A first hat portion is inserted through an opening of a rotor. A second hat portion is inserted through the opening of the rotor such that the first and second hat portions are nested. The first hat portion is rotated within the opening such that each of a plurality of first curved projections formed on the first hat portion contact one of a plurality of first side portions of a plurality of radial recesses of the opening. The second hat portion is also rotated within the opening such that each of a plurality of second curved projections formed on the second hat portion contact one of a plurality of second side portions of the plurality of radial recesses of the opening. Finally, the first and second hat portions are secured together to form a hat assembly.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a front-view of a rotor according to one embodiment of the present invention,

FIG. 2 is a side-view of the rotor of FIG. 1,

FIG. 3 is a cross-sectional view of the rotor of FIG. 2 along line 3-3,

FIG. 4 is an interior view of a hat assembly according to one embodiment of the present invention,

FIG. 5 is a cross-sectional view of the hat assembly of FIG. 4 along line 5-5,

FIG. 6 is side-view of a hat assembly according to one embodiment of the present invention,

FIG. 7 is a cross-sectional view of the hat assembly of FIG. 6 along line 7-7,

FIG. 8 is a rear view of a brake disc assembly according to one embodiment of the present invention,

FIG. 8A is a zoom view of one portion of the brake disc assembly of FIG. 8, and

FIG. 9 is a side-view of the brake disc assembly of FIG. 8.

### DETAILED DESCRIPTION OF THE PREFERRED EMBODIMENT

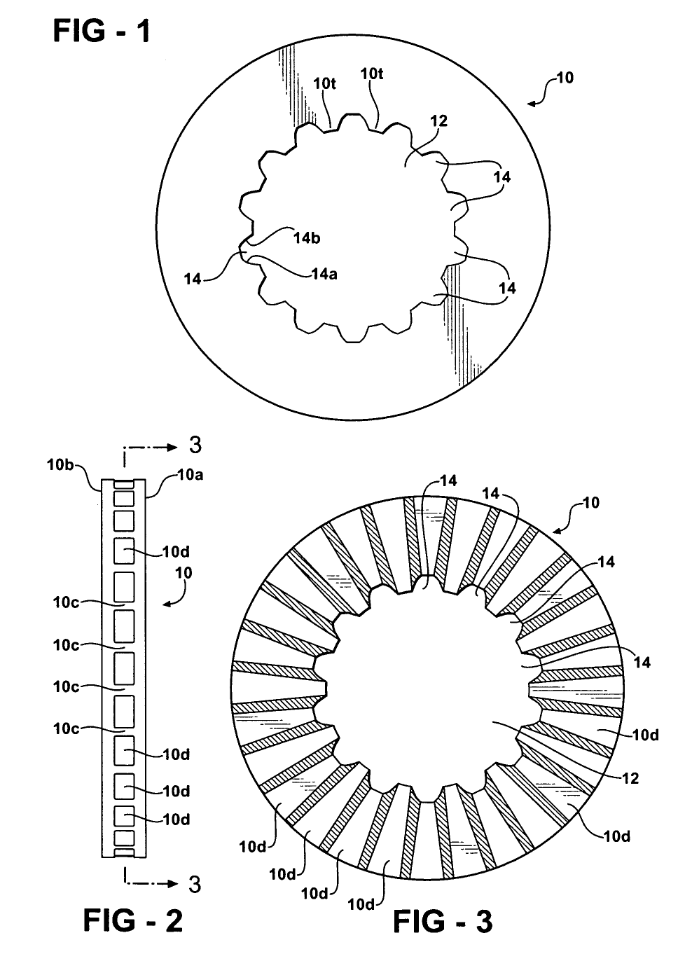

Referring to FIG. 1, a rotor portion 10 of a brake disc assembly 100 according to one embodiment of the present invention is disclosed. The rotor 10 includes an opening 12 disposed in its interior. This opening 12 is capable of receiving and securing a hat assembly 50, as described more fully below. The opening 12 includes a plurality of radial recesses 14 extending in an outwardly direction from the center of the rotor 10. These radial recesses 14 include first and second sides or side portions 14a and 14b. In a preferred embodiment, these side portions have the shape of an involute with respect to the curved projections of the hat assembly, as described more fully below. Between each of the radial recesses 14 is a rotor tooth 10t.

FIG. 2 is a side-view of rotor 10. Rotor 10 is comprised of two annular portions 10a and 10b with a plurality of ribs or vanes 10c that connect the two annular portions 10a and 10b, as is well known in the art. While the discussion below is directed to this traditional construction of rotor 10, the invention is not limited to such a construction and encompasses rotors of different configurations, for example, a rotor 10 made of one solid piece of material. The arrangement of the annular portions 10a and 10b and the connecting vanes 10c in rotor 10 of FIG. 2 form a plurality of cooling ducts or passageways 10d. In a preferred embodiment, these passageways 10d are aligned with the radial recesses 14 of the rotor. These passageways 10d allow for circulation of air behind the annular portions 10a and 10b to cool the rotor 10, as is well known in the art. FIG. 3 is a cross-sectional view of rotor 10 along line 3-3 and illustrates more completely the passageways 10d and connecting vanes 10c. In a preferred embodiment, the rotor 10 is composed of carbon-fiber reinforced silicon carbide, although any other suitable material may be used (e.g., cast iron, steel, metal matrix composite, carbon fiber reinforced ceramic, carbon-carbon, titanium and titanium alloys).

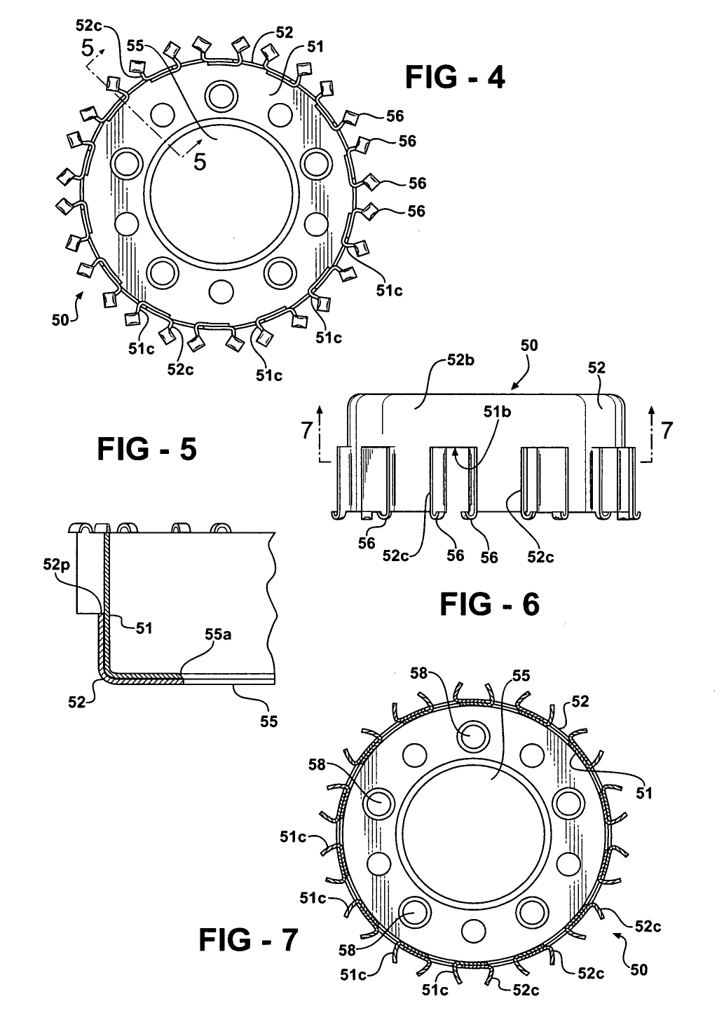

The hat assembly 50 of the brake disc assembly 100 according to one embodiment of the present invention is illustrated in FIGS. 4-7. FIG. 4 shows the completed hat assembly 50 with first hat portion 51 nested within second hat portion 52. The hat assembly is preferably constructed of stainless steel, although any other suitable material may be used. The two hat portions 51 and 52 are preferably attached to each other, most preferably by welding their respective bowl-shaped body portions 51b and 52b together when nested and properly aligned, as described more fully below. FIG. 5 is a cross-sectional view of the hat assembly 50 along line 5-5. Each of the first and second hat portions 51 and 52 includes an opening 55 in their center. This hat opening 55 is designed to receive a pilot on the end of an axle or similar member. The hat opening 55 in the first hat portion 51 preferably includes a chamfered edge 55a to assist in the insertion of the pilot axle or similar member through the hat opening 55. Curved projections 51c and 52c, respectively, of the first and second hat portions 51 and 52 extend radially outwardly from the center of the hat assembly 50. These curved projections 51c and 52c are designed to interact with the radial recesses 14 of the rotor 10, as described more fully below.

The hat assembly 50 is further described with respect to FIG. 6. In FIG. 6, the bowl-shaped body 52b of the second hat portion 52 is shown. Preferably, curved projections 52c extend outwardly from the bowl-shaped body 52b in both the axial and radial direction of the second hat portion 52. In a preferred embodiment, these curved projections 52c include curved tabs 56 that provide a more secure attachment of the hat assembly 50 to the rotor 10, as described more fully below. These tabs 56 can take any shape including, but not limited to, the preferred C-shaped cross-section illustrated in FIGS. 5 and 6. Alternatively, the tabs 56 may be straight, angled or even replaced by projections or similar structures. The first hat portion 51 has a similar, but complementary, construction to that of the second hat portion 52.

As illustrated in FIG. 7, which is a cross-sectional view of the hat assembly 50 of FIGS. 4-6, in a preferred embodiment the curved projections 51c and 52c of the hat portions 51 and 52 have a substantially check-mark shaped construction, with one leg of the check mark being aligned with the circumference of the bowl-shaped body 52b and 51b and the other leg extending outwardly therefrom. The exact shape of the curved projections 51c and 52c is unimportant, and other shapes besides the preferred check-mark shape are within the scope of the invention, e.g., U-, V-, or C-shapes. Both hat portions 51 and 52 further comprise bolt openings 58 that allow for the hat assembly 50 to be bolted to an axle or other member.

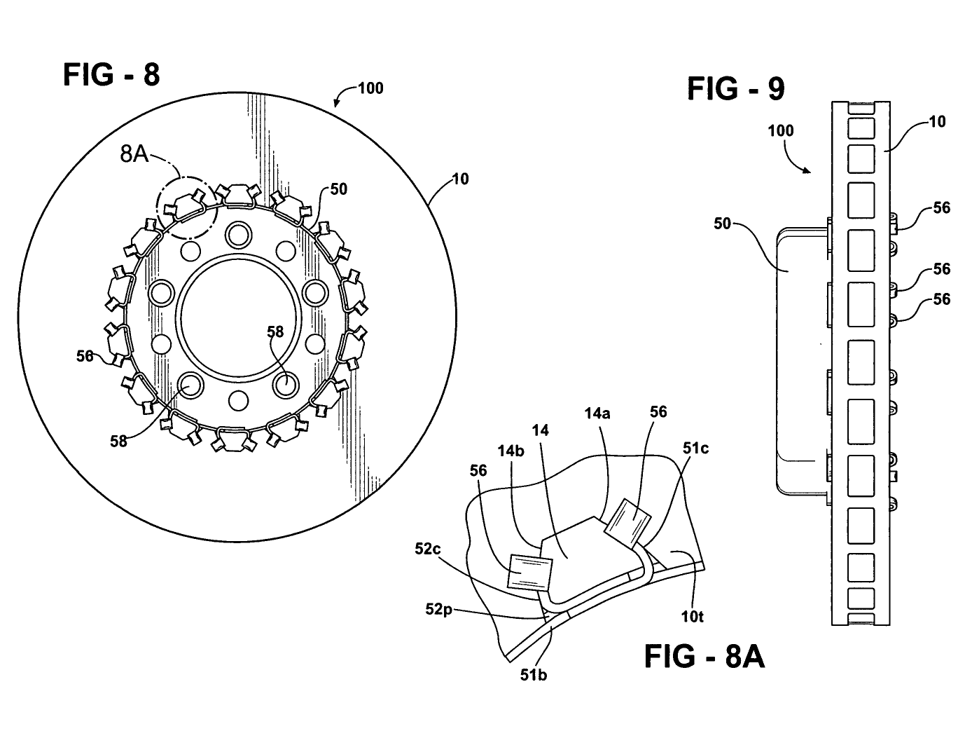

The complete brake disc assembly 100 is illustrated in FIGS. 8 and 9 and comprises the hat assembly 50 and rotor 10. The brake disc assembly 100 is preferably constructed according to the following method. In a preferred embodiment illustrated, the first hat portion 51 is inserted through the rotor opening 12 by aligning the curved projections 51c with the radial recesses 14 and moving the hat assembly through the rotor opening 12 (in the FIG. 8 illustration, the direction is outwardly from the page). The first hat portion 51 is then rotated with respect to the rotor 10 in the clockwise direction of the illustration, such that the tabs 56 of the first hat portion extend partially over the face of the rotor 10. Then, the second hat portion 52 is inserted in a similar manner to that of the first hat portion 51, such that the bowl-shaped body 52b of the second hat portion 52 envelopes the bowl-shaped body portion 51b of the first hat portion 51 in a nesting configuration. The second hat portion 52 is then rotated in a counter-clockwise direction with respect to the rotor 10 and first hat portion 51. As illustrated in the zoom view of FIG. 8, this method arranges the rotor 10, the first hat portion 51 and second hat portion 52 such that the curved projections 51c of the first hat portion 51 contact the first side portions 14a of the radial recesses 14, the curved projections 52c of the second hat portions 52 contact the second side portions 14b of the radial recesses 14 and the tabs 56 project over the face of the rotor 10. In another embodiment, the first hat portions 51 is engaged with the rotor 10 by insertion in one direction and the second hat portion 52 is inserted in the opposite direction such that the first and second hat portions 51 and 52 are nested. Other assembly methods are within the scope of the invention so long as the first and second hat portions 51 and 52 are nested together and secured to the rotor 10.

In a preferred embodiment, the hat portions 51 and 52 are rotated as described with forces sufficient to pre-load the curved projections 51c and 52c such that contact is maintained between the curved projections and the radial recesses over a wide range of operating conditions. In a preferred embodiment, the curved projections 51c and first side portions 14a, and the curved projections 52c and the second side portions 14b, have the shape of an involute when the hat assembly 50 is in the assembled and preloaded condition. This involute relationship provides for the best complementary mating between the hat assembly 50 and the rotor 10. As the rotor 10 temperature increases, the radial recesses 14 will increase in size due to thermal expansion. By preloading the curved projections 51c and 52c with a sufficient force, the hat assembly 50 may compensate for this size increase and ensure sufficient contact between the hat assembly 50 and rotor 10. In order to maintain the preloaded force, the hat portions 51 and 52 are rotated independently in opposite directions and then securely attached together, preferably by welding as described above.

In the side view of the brake disc assembly 100 in FIG. 9, the bowl-shaped bodies 51b and 52b of the hat assembly 50 extend outwardly from one side of the rotor 10 and the tabs 56 extend from the other side of the rotor 10. In order to prevent the rotor 10 from detaching from the hat assembly 50, the rotor 10 is secured between the top portion 52p of the bowl-shaped body 52c of the second hat portion 52 and the tabs 56, as is most clearly illustrated in the zoom view of FIG. 8. The tabs 56 prevent the rotor 10 from detaching from the hat assembly 50 in one direction (in FIG. 9, the tabs 56 prevent the rotor 10 from moving to the right and detaching from the hat assembly). To prevent the rotor 10 from detaching from the hat assembly 50 in the opposite direction, the rotor 10 is arranged such that the rotor teeth 10t contact the top portion 52p of the bowl-shaped body 52b. In this construction, the rotor 10 is secured from movement in the axial direction of the hat assembly 50 because it is secured between tabs 56 and the top portion 52p of the bowl-shaped body 52b of the second hat portion 52. In this manner, the rotor 10 and hat assembly 50 are fastened together to complete the brake disc assembly 100. In an alternative embodiment, the rotor teeth 10t contact both the top portion 52p of the bowl-shaped body 52b as well as the side of the bowl-shaped body 51b of the first hat portion 51. In yet another alternative embodiment, which is not illustrated, the rotor teeth 10t contact the top portion of the bowl-shaped body 51c (similar to that described above with respect to the top portion 52p of the bowl shaped body 52b) and the rotor 10 is secured from movement in the axial direction of the hat assembly 50 by being secured between tabs 56 and the top portion of the bowl-shaped body 51b of the first hat portion 51.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A brake disc assembly, comprising:
a rotor, said rotor comprising an opening, said opening comprising a plurality of radial recesses, wherein each of said plurality of radial recesses comprises a first and second side portion, and
a hat assembly operably connected to said rotor, said hat assembly comprising a first hat portion and a second hat portion, each of said first and second hat portions comprising a bowl-shaped body portion, a hat opening, and a plurality of curved projections, each of said plurality of curved projections extending outwardly from said bowl-shaped body portion, wherein:
said first hat portion is arranged such that each of said curved projections of said first hat portion contact one of said first side portions,
said second hat portion is arranged such that each of said curved projections of said second hat portion contact one of said second side portions, and
said first hat portion is nested within said second hat portion.

2. The brake disc assembly of claim 1, wherein each of said plurality of curved projections of said first hat portion and said first side portions have the shape of an involute.

3. The brake disc assembly of claim 2, wherein said bowl-shaped body portion of said second hat portion comprises a top portion, said top portion being capable of restraining differential movement between said rotor and said hat assembly in an axial direction.

4. The brake disc assembly of claim 3, wherein each of said plurality of curved projections comprises a curled tab, said curled tabs being capable of restraining differential movement between said rotor and said hat assembly in an axial direction.

5. The brake disc assembly of claim 4, wherein said rotor is formed of a material selected from the group consisting of cast iron, steel, carbon-carbon, metal matrix composite, carbon fiber reinforced ceramic, carbon fiber reinforced silicon carbide, titanium and titanium alloys.

6. The brake disc assembly of claim 2, wherein each of said plurality of curved projections comprises a curled tab, said curled tabs being capable of restraining differential movement of said rotor and said hat assembly in an axial direction.

7. The brake disc assembly of claim 6, wherein said rotor is formed of a material selected from the group consisting of cast iron, steel, carbon-carbon, metal matrix composite, carbon fiber reinforced ceramic, carbon fiber reinforced silicon carbide, titanium and titanium alloys.

8. The brake disc assembly of claim 2, wherein said rotor is formed of a material selected from the group consisting of cast iron, steel, carbon-carbon, metal matrix composite, carbon fiber reinforced ceramic, carbon fiber reinforced silicon carbide, titanium and titanium alloys.

9. The brake disc assembly of claim 1, wherein said bowl-shaped body portion of said second hat portion comprises a top portion, said top portion being capable of restraining differential movement between said rotor and said hat assembly in an axial direction.

10. The brake disc assembly of claim 9, wherein said rotor is formed of a material selected from the group consisting of cast iron, steel, carbon-carbon, metal matrix composite, carbon fiber reinforced ceramic, carbon fiber reinforced silicon carbide, titanium and titanium alloys.

11. The brake disc assembly of claim 1, wherein each of said plurality of curved projections comprises a curled tab, said curled tabs being capable of restraining differential movement of said rotor and said hat assembly in an axial direction.

12. The brake disc assembly of claim 1, wherein said rotor is formed of a material selected from the group consisting of cast iron, steel, carbon-carbon, metal matrix composite, carbon fiber reinforced ceramic, carbon fiber reinforced silicon carbide, titanium and titanium alloys.

13. A method of assembling a brake disc assembly, said brake disc assembly comprising a rotor, said rotor comprising an opening, said opening comprising a plurality of radial recesses, wherein each of said plurality of radial recesses comprises a first and second side portion, comprising the steps of:
inserting a first hat portion through said opening of said rotor,
inserting a second hat portion through said opening of said rotor such that said first hat portion and said second hat portion are nested,
rotating said first hat portion within said opening such that each of a plurality of first curved projections formed on said first hat portion contact one of said first side portions,
rotating said second hat portion within said opening such that each of a plurality of second curved projections formed on said second hat portion contact one of said second side portions, and
securing said first and second hat portions together to form a hat assembly.

14. The method of claim 13, wherein the step of rotating said first hat portion within said opening comprises preloading said plurality of first curved projections with a force sufficient to maintain contact between said plurality of first curved projections and said first side portions over varied operating conditions.

15. The method of claim 14, wherein each of said plurality of first curved projections comprises a curled tab, said curled tabs being capable of restraining differential movement of said rotor and said hat assembly in an axial direction.

16. The method of claim 15, wherein said bowl-shaped body portion of said second hat portion comprises a top portion, said top portion being capable of restraining differential movement between said rotor and said hat assembly in an axial direction.

17. The method of claim 16, wherein said rotor is formed of a material selected from the group consisting of cast iron, steel, carbon-carbon, metal matrix composite, carbon fiber reinforced ceramic, carbon fiber reinforced silicon carbide, titanium and titanium alloys.

18. The method of claim 13, wherein each of said plurality of first curved projections comprises a curled tab, said curled tabs being capable of restraining differential movement of said rotor and said hat assembly in an axial direction.

19. The method of claim 18, wherein said bowl-shaped body portion of said second hat portion comprises a top portion, said top portion being capable of restraining differential movement between said rotor and said hat assembly in an axial direction.

20. The method of claim 19, wherein said rotor is formed of a material selected from the group consisting of cast iron, steel, carbon-carbon, metal matrix composite, carbon fiber reinforced ceramic, carbon fiber reinforced silicon carbide, titanium and titanium alloys.
